(19) United States
(12) Patent Application Publication
(10) Pub. No.: US 2026/0237325 A1
(43) Pub. Date: Aug. 13, 2026

(54) PROTECTIVE COLLECTIBLE HOLDERS, SYSTEMS COMPRISING THE HOLDERS AND COLLECTIBLES, AND METHODS TO PROTECT AND AUTOGRAPH THE COLLECTIBLES RETAINED WITHIN THE HOLDERS

(71) Applicant: UNIQUE COLLECTIBLES TECHNOLOGIES LLC, New York, NY (US)

(72) Inventors: Peter E. ARNELL, New York, NY (US); Youssef SAAFAN, New York, NY (US); Gabriel VIZCARRONDO CANCIO, New York, NY (US)

(73) Assignee: UNIQUE COLLECTIBLES TECHNOLOGIES LLC, New York, NY (US)

(21) Appl. No.: 19/048,115

(22) Filed: Feb. 7, 2025

(51) Int. Cl. G09F 1/10

(52) U.S. Cl. CPC G09F 1/10

(57) ABSTRACT

Protective collectible holders are configured to retain at least one collectible therein and each comprise a storage area disposed between a backing layer and a cover layer, wherein the storage area is configured to receive and retain the collectible therein. The holders further comprise an opening disposed between the backing layer and the cover layer and configured such that the collectible is insertable into the storage area through the opening and an autograph window extending through a total thickness of the cover layer such that an exposed portion of the collectible is accessible for autographing through the autograph window. Autograph systems comprising the holders and collectibles and methods to protect and autograph the collectibles are also disclosed herein.

### FIELD OF THE DISCLOSURE

The present disclosure is generally directed to one or more protective collectible holders configured and/or adapted to receive, retain, protect, store, house, and/or secure one or more collectibles therein. The one or more collectibles may be protected by the one or more protective collectible holders for shipping, transport, and/or autographing the one or more collectibles. Each holder of the one or more protective collectible holders may have at least one autograph window for accessing and/or autographing an exposed portion of each collectible that is secured, retained, and/or stored within each holder. Further, the present disclosure is generally directed to one or more autograph systems comprising the one or more collectibles protected, stored, retained, and/or secured within the one or more protective collectible holders. Still further, the present disclosure is generally directed to kits comprising one or more autograph systems and/or methods of retaining, protecting, and/or autographing the one or more collectibles within the one or more protective collectible holders during shipping, transporting, and/or autographing of the one or more collectibles.

Traditionally, large volumes of collectibles, such as, for example, sports trading cards are sent out, shipped, and/or transported to an athlete for signing/autographing by that athlete; however, the known signing/autographing systems and processes pose several challenging issues that often lead to or result in damage to one or more of the collectibles. Typically, this damage to the collectible greatly impacts the subsequent quality grading of the damaged collectible.

In contrast to the known systems and processes, the present protective collectible holders, autograph systems, kits, and methods disclosed herein overcome and/or avoid the challenges and issues associated with the known system and processes by enhancing the protection of the collectible(s) during transportation, shipping, signing/autographing, and returning of the collectibles, especially when handling batches of several hundred collectibles and/or trading cards. As a result, the present holders, systems, kits, and methods disclosed herein ensure the collectibles are maintained and/or remain in pristine condition during the signing/autographing by the signer(s). In addition to overcoming the above-mentioned challenging issues, the present holders, systems, kits, and method disclosed herein also may: prevent smudging of signatures on the collectibles; minimize edge wear, bending, or creasing of the collectibles; reducing potential for damage of the collectibles during shipping; accommodate collectibles and/or cards of varying thicknesses; develop a scalable, innovative, and robust experience for the signer(s), and/or create high-end packaging for the collectibles that may instantly communicate value for encouraging the careful handling of the collectibles by the signer(s).

### SUMMERY OF THE DISCLOSURE

In one or more embodiments, protective holders are configured to retain at least one collectible and comprise: a storage area disposed between a backing layer and a cover layer and configured to receive and retain a collectible therein; an opening disposed between the backing layer and the cover layer and configured such that the collectible is insertable into the storage area through the opening; and an autograph window extending through a total thickness of the cover layer such that an exposed portion of the collectible is accessible for autographing through the autograph window when the collectible is disposed within the storage area.

In an embodiment, the backing layer and the cover layer are integrally formed together.

In an embodiment, the cover layer is movably connected to the backing layer.

In an embodiment, the protective holders may further comprise a hinge or magnets movably connecting the cover layer to the backing layer.

In an embodiment, the protective holders may further comprise a core layer connected to the backing layer and comprising the storage area configured to receive the collectible therein when the protective holder is disposed in an open configuration.

In an embodiment, the core layer is disposed between the backing layer and the cover layer when the protective holder is disposed in a closed configuration.

In an embodiment, an exposed portion of the collectible is accessible through the autograph window when the collectible is retained within the storage area of the core layer and the protective holder is disposed in the closed configuration.

In an embodiment, the protective holders may further comprise at least one lip of the cover layer disposed adjacent to the autograph window such that the at least one lip covers at least one unexposed portion of the collectible when the collectible is retained within the storage area.

In an embodiment, all edges of the collectible are covered by portions of the cover layer adjacent to the window when the collectible, in its entirety, is disposed between the backing layer and the cover layer or the holder is disposed in a closed position such that the cover layer is adjacent to the core layer.

In one or more embodiments, autograph systems comprise: at least one protective holder; and a collectible retained within the storage area of the protective holder such that an exposed portion of the collectible is accessible for autographing through the autograph window of the protective holder.

In an embodiment, the collectible retained within the storage area is a collectible trading card.

In an embodiment, the protective holder is a semi-rigid card holder configured to retain the collectible trading card therein or the autograph window is movable with respect to the exposed portion of the collectible trading card.

In an embodiment, the protective holder further comprises a core layer comprising the storage area and connected to the backing layer, wherein the cover layer is movably connected to the core layer or the cover layer

In one or more embodiments, methods may protect at least one collectible and comprise: retaining a collectible in the storage area of at least one protective holder such that an exposed portion of the collectible is accessible for autographing through the autograph window of the protective holder.

In an embodiment, the methods may further comprise: autographing the exposed portion of the collectible through the autograph window.

In an embodiment, the methods may further comprise: packing the protective holder and retained collectible into container of a kit.

In an embodiment, the methods may further comprise: shipping or transporting the kit.

In an embodiment, the methods may further comprising at least one: receiving the shipped or transported kit; and removing the packed protective holder and retained collectible from the kit.

In an embodiment, the retained collectible is a collectible trading card.

In an embodiment, the methods may further comprise: inserting the collectible trading care into a semi-rigid card holder as the protective holder.

### BRIEF DESCRIPTION OF THE DRAWINGS

The present disclosure is best understood from the following detailed description when read with the accompanying Figures. It is emphasized that, in accordance with the standard practice in the industry, various features are not drawn to scale. In fact, the dimensions of the various features may be arbitrarily increased or reduced for clarity of discussion.

FIG. 1 illustrates a front plan view of a protective collectible holder having an autograph window and an opening for receiving a collectible, according to one or more embodiments of the disclosure.

FIG. 2 illustrates a front plan view of a collectible retained within an internal area of the holder shown in FIG. 1 such that an exposed portion of the collectible is accessible through the autograph window, according to one or more embodiments of the disclosure.

FIG. 3 illustrates a front plan view of the collectible retained the holder shown in FIG. 1 and being autographed through the autograph window with a writing device, according to one or more embodiments of the disclosure.

FIG. 4 illustrates a front plan view of a protective collectible holder having an autograph window and an opening for receiving a collectible, according to one or more embodiments of the disclosure.

FIG. 5 illustrates a front plan view of the collectible retained the holder shown in FIG. 4 and being autographed through the autograph window with a writing device, according to one or more embodiments of the disclosure.

FIG. 6 illustrates a front plan view of a binder page comprising a plurality of protective collectible holders having autograph windows and opening for receiving a plurality of collectibles, according to one or more embodiments of the disclosure.

FIG. 7 illustrates a perspective view of at least one binder page shown in FIG. 6 connected to a closable binder such that collectibles retained within the holders may be autographed through the autograph windows with a writing device, according to one or more embodiments of the disclosure.

FIG. 8 illustrates a perspective view of an autograph kit for autographing collectibles retained within the closable binder shown in FIG. 8, according to one or more embodiments of the disclosure.

FIG. 9 illustrates an exploded perspective view of a multi-layered protective collectible holder having a plurality opening for receiving a plurality of collectibles and a plurality of autograph windows for accessing and autographing the collectibles, according to one or more embodiments of the disclosure.

FIG. 10 illustrates a front plan view of the multi-layered holder shown in FIG. 9, wherein the openings of a middle core layer for receiving collectibles are shown in dashed-and/or broken-lines, according to one or more embodiments of the disclosure.

FIG. 11 illustrates a front plan view of the multi-layered holder shown in FIG. 9 such that the autograph windows provide access to the collectibles retained within the multi-layered holder, according to one or more embodiments of the disclosure.

FIG. 12 is a cross-section view of the multi-layered holder taken along the line A-A as shown in FIG. 11, according to one or more embodiments of the disclosure.

FIG. 13 is an enlarged view of section/portion B of the multi-layered holder shown in FIG. 12, according to one or more embodiments of the disclosure

FIG. 14 illustrates an exploded perspective view of a multi-layered protective collectible holder having a plurality opening for receiving a plurality of collectibles and a plurality of autograph windows for accessing and autographing the collectibles, according to one or more embodiments of the disclosure.

FIG. 15 illustrates a front plan view of the multi-layered holder shown in FIG. 14, wherein the openings of a middle core layer for receiving collectibles are shown in dashed-and/or broken-lines, according to one or more embodiments of the disclosure.

FIG. 16 illustrates a perspective view of a multi-layered protective collectible holder in an open and/or loading position and having a plurality of openings or storage areas for receiving a plurality of collectibles and a plurality of autograph windows for accessing and autographing the collectibles, according to one or more embodiments of the disclosure.

FIG. 17 illustrates a perspective view of the multi-layered holder shown in FIG. 16 in a closed and/or autographing position such that the collectibles are accessible for autographing through the autograph windows of the holder, according to one or more embodiments of the disclosure.

FIG. 18 illustrates a perspective view of a multi-layered protective collectible holder in an open and/or loading position and having a plurality of openings or storage areas for receiving a plurality of collectibles and a plurality of autograph windows for accessing and autographing the collectibles, according to one or more embodiments of the disclosure.

FIG. 19 illustrates a perspective view of the multi-layered holder shown in FIG. 18 in a closed and/or autographing position such that the collectibles are accessible for autographing through the autograph windows of the holder, according to one or more embodiments of the disclosure.

FIG. 20 illustrates a perspective view of an autograph kit for autographing collectibles retained within the multi-layered holder shown in FIG. 17, according to one or more embodiments of the disclosure.

### DETAILED DESCRIPTION

Illustrative examples of the subject matter claimed below will now be disclosed. In the interest of clarity, not all features of an actual implementation are described in this specification. It will be appreciated that in the development of any such actual implementation, numerous implementation-specific decisions may be made to achieve the developers'specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

Further, as used herein, the article “a” is intended to have its ordinary meaning in the patent arts, namely “one or more.” Herein, the term “about” when applied to a value generally means within the tolerance range of the equipment used to produce the value, or in some examples, means plus or minus 10%, or plus or minus 5%, or plus or minus 1%, unless otherwise expressly specified. Further, herein the term “substantially” as used herein means a majority, or almost all, or all, or an amount with a range of about 51% to about 100%, for example. Moreover, examples herein are intended to be illustrative only and are presented for discussion purposes and not by way of limitation.

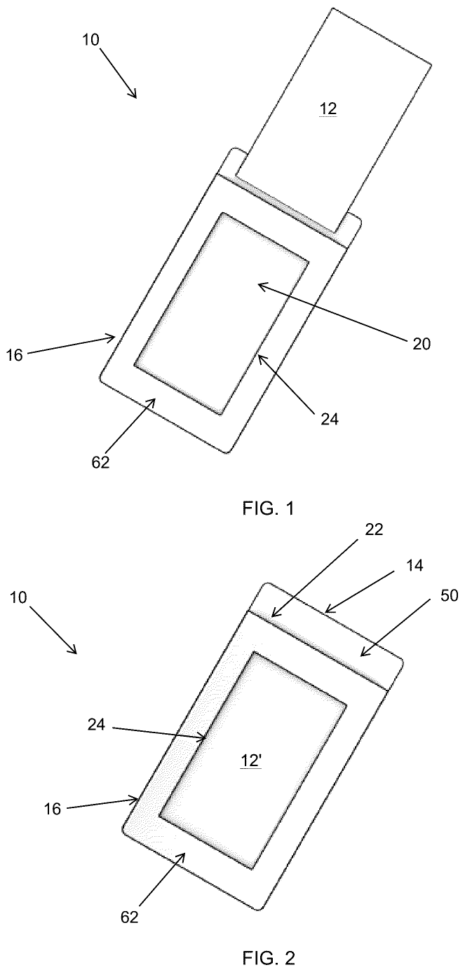

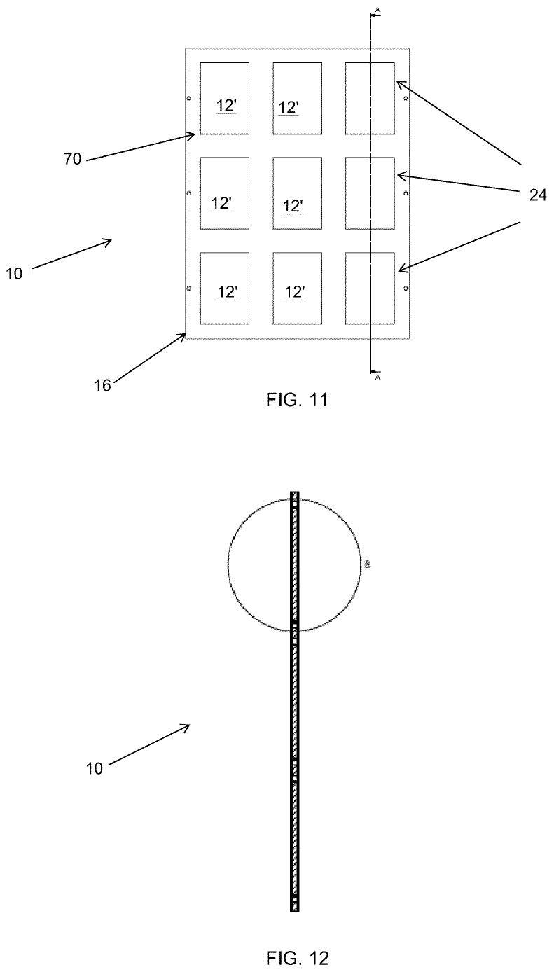

FIGS. 1-20, wherein like numerals represent like or similar structural features and/or components, at least one protective collectible holder 10 (hereinafter “the holder 10” or “the holders 10”) is provided and/or illustrated for protecting at least one collectible 12 (hereinafter “the collectible 12” or “the collectibles 12”) during at least one of a shipping, transporting, signing, autographing and/or returning process associated with the collectible 12. The holder 10 may have, comprise, or consist of at least one backing layer 14 (hereinafter “the backing layer 14”), at least one cover layer 16 (hereinafter “the cover layer 16”), and an optional immediate or core layer 18 (hereinafter “the core layer 18”) as shown in FIGS. 1-5, 9, 12-14, and 16-19. The holder 10 comprises at least one retainer and/or storage area 20 (hereinafter “the storage area 20” or “the storage areas 20”) that is adapted, configured, sized, and/or shaped to receive, hold, house, protect, retain, and/or store the collectible 12 therein.

In some embodiments, the collectible 20 or the collectibles 20 may be selected from the group consisting of at least one piece of artwork, one or more trading cards, one or more collectible cards, one or more sport-related cards, one or more non-sport trading cards, one or more fantasy-based gameplay cards, one or more fantasy art cards, one or more collectible books or comic books, one or more collectible postcards, one or more collectible posters, one or more photographs, one or more collectible manuscripts, one or more collectible stamps, at least one memorabilia piece, at least one metal-based collectible, at least one paper-or pulp-based collectible, at least one wax-based collectible, at least one framed collectible selected from at least one painting, at least one lithograph, at least one photograph, or at least one jersey, one or more collectible coins and/or gemstones, one or more antiques and/or artifacts, at least one piece of sports memorabilia, or a combination thereof. The collectible 20 or the collectibles 20 may be made of at least one material selected from the group consisting of at least one paper-or pulp-based material, at least one plastic-or polymer-based material, at least one metal-or chrome-based material, at least one composite material, at least one organic material, and a combination thereof.

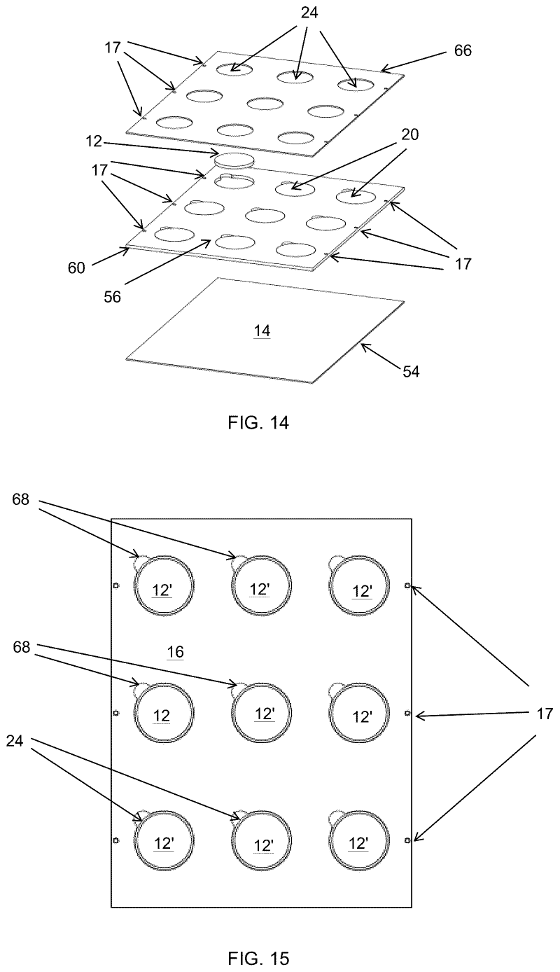

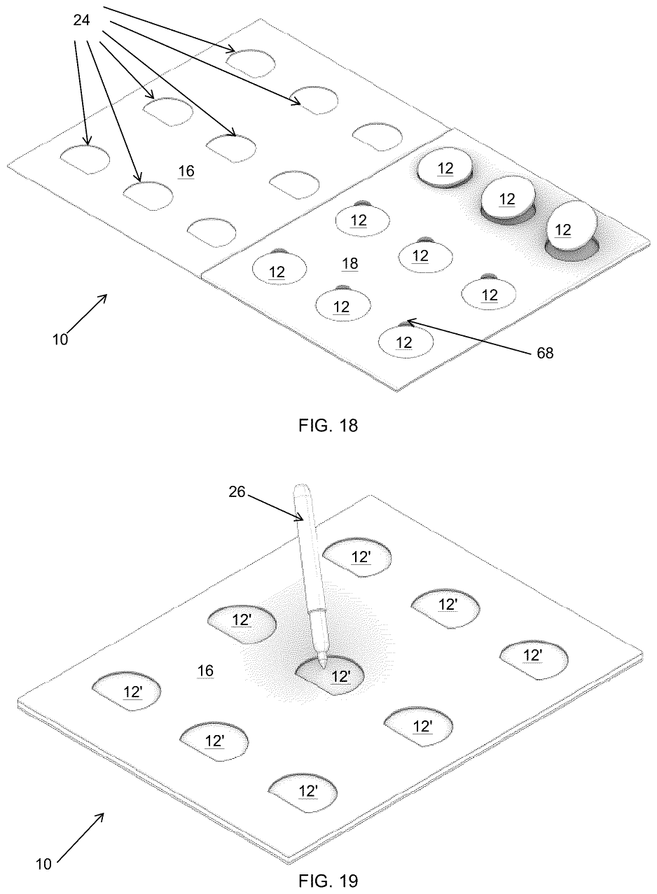

In one or more embodiments, the storage area 20 is defined between the backing layer 14 and the cover layer 16 as shown in FIGS. 1 and 6 and the holder 10 may have at least one opening 22 (hereinafter “the opening 22” or “the openings 22”) for loading, moving, pushing, transferring, and/or positioning the collectible 12 into the storage area as shown in FIGS. 1-6. In at least one embodiment, the holder 10 may be a protective sleeve or a semi-rigid card holder adapted, configured, shaped, and/or sized to receive the collectible through the opening 22 and/or subsequently retain, protect, and/or store the collectible 12 within the storage area 20. In some embodiments, the protective sleeve or the semi-rigid card holder is a top-loading sleeve or a top-loading semi-rigid card holder for protecting, retaining, and/or storing at least one polygon-shaped collectible as shown in FIGS. 1-7, at least one circularly-shaped collectible as shown in FIGS. 14 and 18, or a combination thereof (not shown in the drawings).

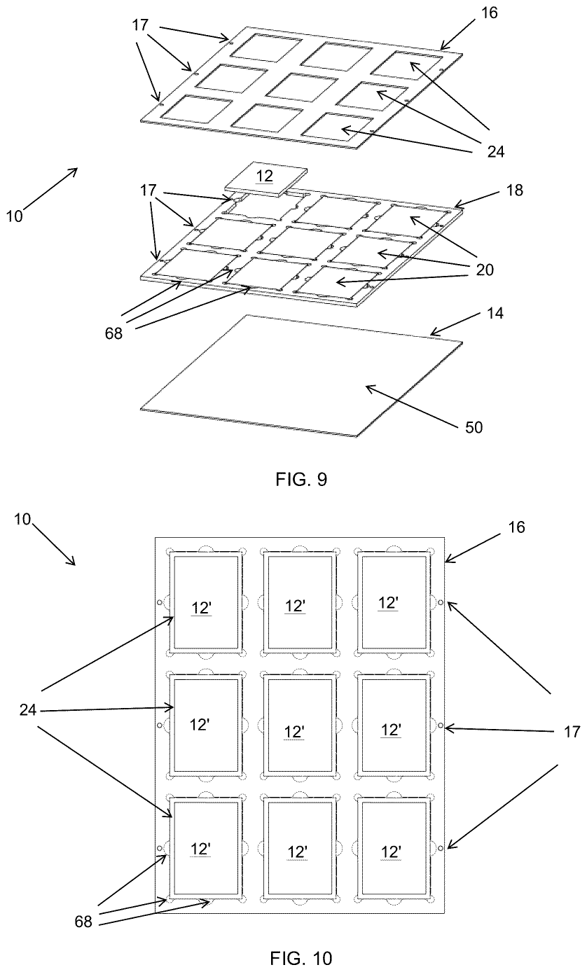

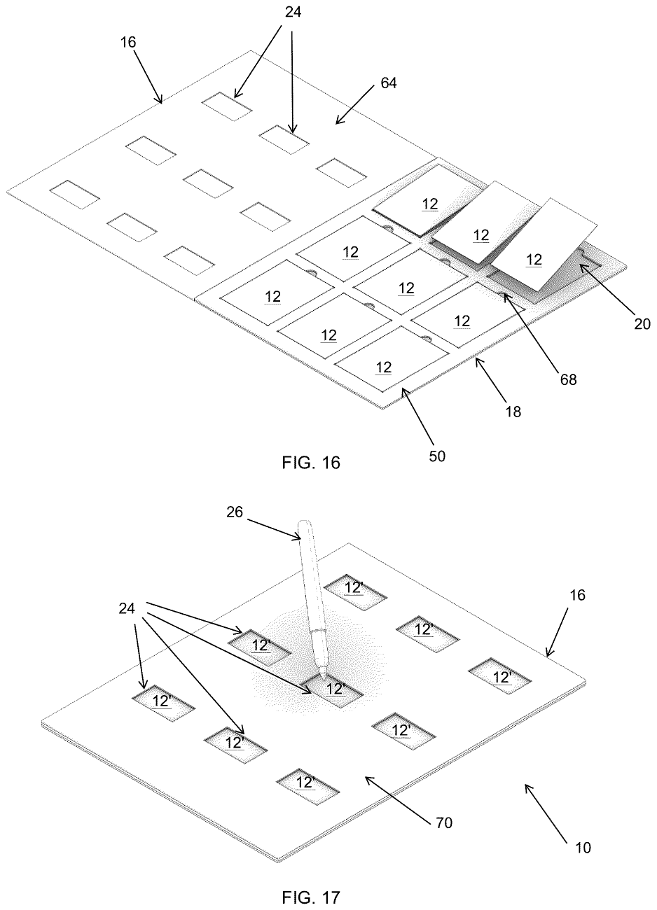

In at least one embodiment, the backing layer 14 and the cover layer 16 (collectively referred to hereinafter as “the backing and cover layers 14, 16”) may be integrally formed together to provide, form, and produce the holder 10. In another embodiment, the backing and cover layers 14, 16 may be hinged or fastened together such that the backing and cover layers 14, 16 are movable, twistable, rotatable, and/or flexible with respect to each other. In some embodiments, one or more fasteners or fastening means may connect, attach, couple, and/or affix the cover layer 16 to the backing layer 14. In an embodiment, the one or more fasteners or fastening means may be a hinge 15 as shown in FIGS. 16 and 18 that connects, attaches, couples, or affixes the backing and cover layers 14, 16 together. In another embodiment, the one or more fasteners or fastening means may be or comprise one or more magnets 17 as shown in FIGS. 9-11, 14 and 15 that may removably connect, attach, couple, or affix the cover layer 16 to the backing layer 14 and/or the core layer 18.

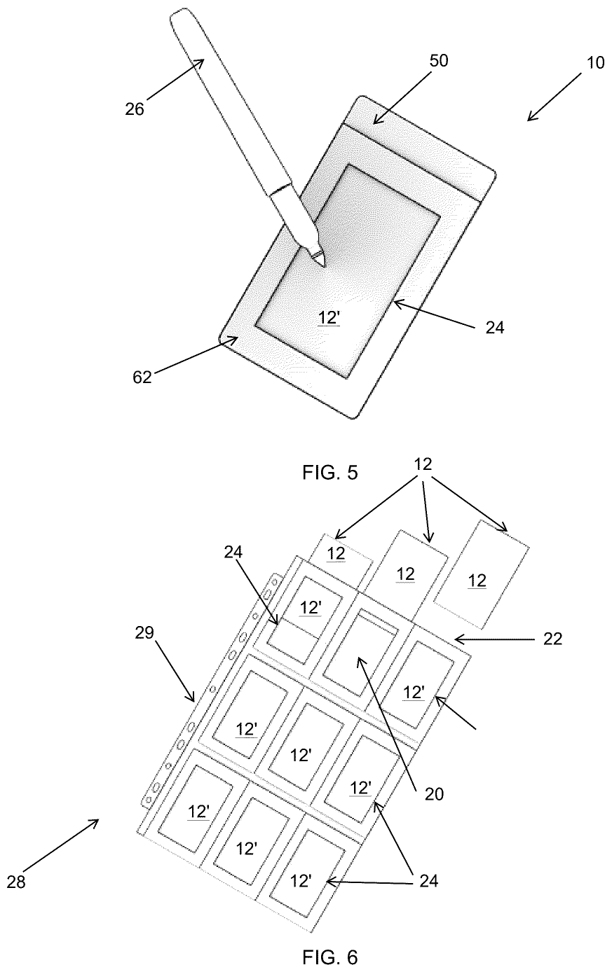

To facilitate the autographing of the collectible 12 while the collectible 12 is or remains protected and/or retained within the storage area 20 of the holder 10, the cover layer 16 comprises at least one autograph window 24 (hereinafter “the window 24” or “the windows 24”) that is adapted, configured, shaped, and/or sized to provide access to the storage area 20 of the holder 10 and/or the collectible 12 retained within the storage area 20, as shown in FIGS. 1-7. As a result, at least one signing area and/or exposed portion 12′ (collectively referred to hereinafter as “the exposed portion 12′” or “the exposed portions 12′”) of the collectible 12 may be accessed through the window 24 for autographing and/or signing the exposed portion 12′ with a writing device 26 as shown in FIGS. 3, 5, 7, 27, and 19. When the collectible 12 is retained or disposed within the storage area 20, the writing device 26 may be utilized by a signer or autographer to autograph and/or sign the exposed portion 12′ of the collectible 12 through the window 24 while one or more remaining portions of the collectible 12 are and/or remain concealed, covered, protected, and/or unexposed by or between the backing and cover layers 14, 16. In an embodiment, the exposed portion 12′ of the collectible 12 is provided, positioned, and/or disposed on a first side of the collectible 12 that is adjacent to the cover layer 16 and/or the window 24 when the collectible 12 is retained or disposed within the storage area 20 and/or protected within the holder 10. In some embodiments, the exposed portion 12′ has a total exposed surface area that may be greater than or less than about 50% of the total surface area of the first side of the collectible 12. In at least one embodiment, the total exposed surface area of the exposed portion 12′ may be less than about 75% or greater than about 25% of the total surface area of the first side of the collectible 12 as shown in FIGS. 4 and 5. In one embodiment, the total exposed surface area of the exposed portion 12′ may be less than about 90% or greater than about 10% of the total surface area of the first side of the collectible 12 as shown in FIG. 6.

In one or more embodiments, the holder 10 is a two-layer system comprising the backing and cover layers 14, 16. In at least one embodiment, the backing and cover layers 14, 16 may be transparent layers that facilitate quick and/or easy inspection of the collectibles 12 and/or the storage areas 20 may receive a set of collectibles 20 such that the collectibles 20 are securely enclosed between the backing and cover layers 14, 16. As a result, the exposed portions 12′ of the collectibles 20 may be accessed through the windows 24 for quick and easy access, signing, and/or autographing. In an embodiment, the transparent layers may be made of at least one acrylic.

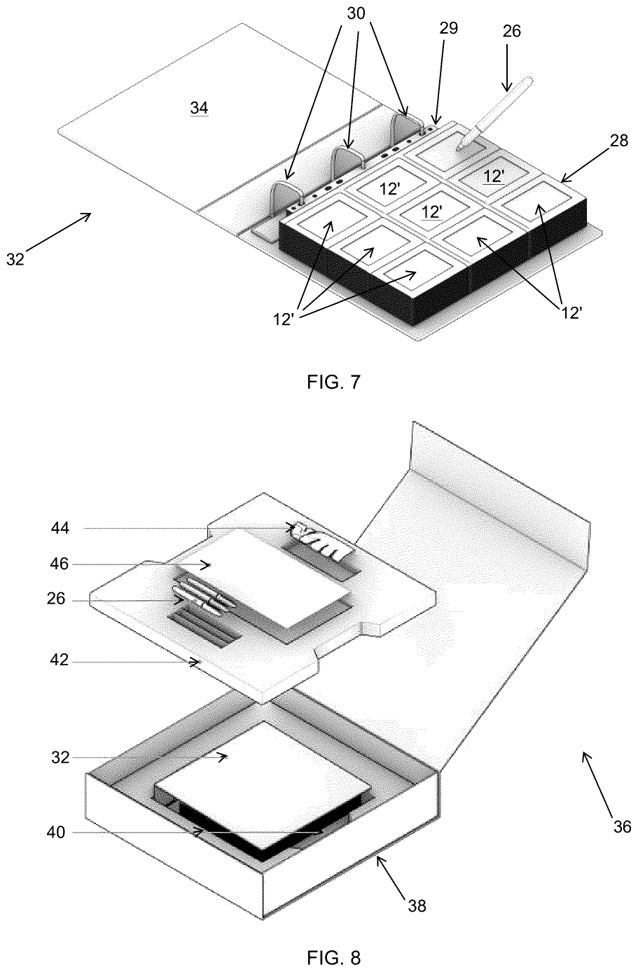

In some embodiments, a binder page 28 may be provided for protecting, retaining, and/or storing a plurality of the collectibles 12 during an autographing process or method to minimize damage to unexposed portions 12′ of the collectibles 12 as shown in FIGS. 6 and 7. In an embodiment, the binder page 28 may comprise a plurality of the holders 10, wherein each holder 10 comprises the storage area 20, the opening 22, and the window 24. As shown in FIGS. 6 and 7, the binder page may comprise, for example, nine (9) total holders 10 such that nine (9) collectibles may be protected and retained within the holders 10 of the binder page 28 for autographing during the autographing process or method. Each of the holders 10 of the binder page 28 may be, for example, top-loaded with the collectibles 12 via the openings 22 which may be adjacent to top sides and/or top edges of the holders 10 as shown in FIG. 6. In at least one embodiment, the binder page 28 may be a pocket binder page, wherein each holder 10 is in the form of a pocket comprising the window 24 for accessing the collectible 12 protected, retained, or stored within the pocket and autographing the exposed portion 12′ of the collectible 12 that is retained within the pocket. It should be understood that the present disclosure is not limited to a specific embodiment of the number of holders 10 and/or pockets provided on or in the binder page 28.

In one or more embodiments, at least one binder page 28 (hereinafter “the binder page 28” or “the binder pages 28”) may be connected, attached, coupled, affixed to one or more rings and/or connectors 30 (hereinafter “the connectors 30”) of a closable binder 32 (hereinafter “the binder 32”) as shown in FIG. 7. In some embodiments, the binder page 28 comprises one or more fasteners 29 that may be removably connected, attached, coupled, and/or affixed to the connectors 30 of the closable binder 32. The binder 32 may be disposed or positioned in and/or moved to a first or closed position, wherein a cover 34 of the binder 32 conceals, covers, and protects the binder pages 28 disposed therein and/or the collectables 12 disposed therein and/or within the holders 10 of the binder page(s) 28. The binder 32 may be disposed or positioned in and/or moved to a second or opened position by moving, pivoting, or rotating the cover 34 away from the binder page(s) 28 to access the windows 24 disposed on the holders 10 of the uppermost binder page 28 in the binder 32 such that the exposed portion 12′ of the collectibles 12 is accessible for signing or autographing with the writing device 26. After the collectibles have been signed or autographed, the binder 32 may be disposed or positioned in and/or moved or returned to the first or closed position to protect and/or retain the autographed collectibles 12 within the binder 32, the binder page(s) 28, the holders 10, or a combination thereof

In some embodiments, an autograph kit 36 (hereinafter “the kit 36”) for autographing the collectibles 12 protected, retained, and/or stored within the binder 32 as shown in FIG. 8. In at least one embodiment, the kit 36 comprises a box or container 38 (hereinafter “the container 38”) adapted, configured, shaped, and/or sized to protect, receive, retain, and/or store the binder 32, the binder page(s) 28, the holders 10, and/or the collectibles 12 therein for safe, secure, efficient, and protected shipping and/or transporting of the collectibles 12 retained therein to an autographing site and/or location. In some embodiments, the kit 36 comprises at least one first divider or insert 40 (hereinafter “the first insert 40”) and at least one second divider or insert 42 (hereinafter “the second insert 42”) which are stackable inside the container 38 such that the second insert 42 is disposed above and/or onto the first insert 40 as shown in FIG. 8. The first insert 40 and/or the second insert 42 (collectively referred to hereinafter as “the first and second inserts 40, 42”) and/or the container 38 may be made of at least one material selected from the group consisting of at least one plastic-or polymer-based material, at least one paper-or cardboard-based material, at least one wood-or pulp-based material, at least one foam-based material, at least one desiccant-based material, at least one archival-grade material, and a combination thereof. In an embodiment, the plastic-or polymer-based material may be selected from the group consisting of polyethylene, polyurethane, polypropylene, polycarbonate, polystyrene, ethylene-vinyl acetate, and a combination thereof.

In at least one embodiment, the first insert 40 has at least one recess or opening adapted, configured, shaped, and/or sized to receive, retain, protect, and/or store the binder 32 and/or the second insert 42 has a plurality of recesses or openings adapted, configured, shaped, and/or sized to receive, retain, protect, and/or store at least one selected from the group consisting of one or more inspection gloves 44 (hereinafter “the gloves 44”), at least one information and/or instructional document 46 (hereinafter “the document 46”), one or more writing devices 36, and a combination thereof. Upon closure, shutting, or sealing of the container 38, the kit 36 and the above-mentioned contents of the kit 36 may be safely, securely, and efficiently shipped or transported to the autographing site or location for signing and/or autographing.

In some embodiments, the holder 10 may be, have, comprise, or consist of a plurality of sleeves or semi-rigid card holders with windows 24 for packaging and storing the collectibles 12 in the kit 36. As a result, the kit 36, the holder 10, the binder pages 28, and/or the windows 24 minimize the number of available touch points on the collectibles 12 and/or significantly reduce the risk of damage to the collectibles 12 while the collectibles 12 are being shipped, transported, signed, and/or autographed. Moreover, the kit 36, the holder 10, the binder pages 28, and/or the windows 24 may provide enhanced and/or improved protection for each collectible 12 during shipping, transportation, signing, or autographing of the collectibles 12. In an embodiment, the windows 24 of the holder 10 or the binder pages 28 may be precision-cut autograph windows for facilitating quick and easy signing or autographing of the collectibles retained within the holder 10 or the binder pages 28, respectively.

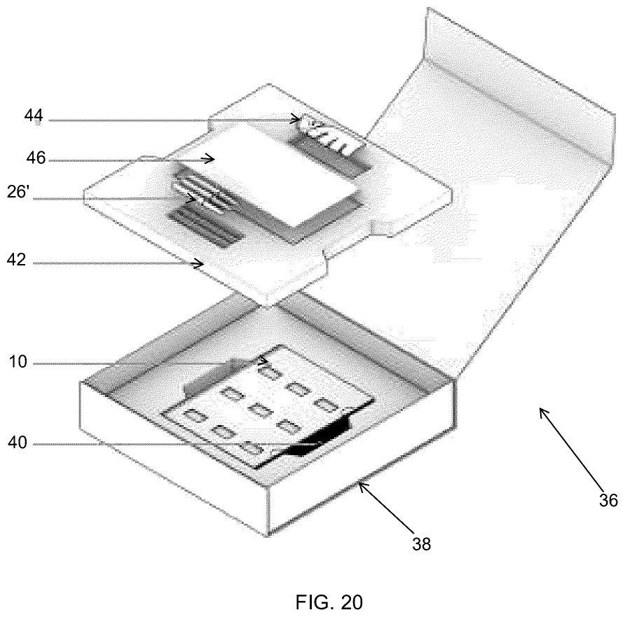

In one or more embodiments, the kit 36, as shown in FIGS. 8 and 20, may be adapted, configured, designed, shaped, and/or sized to provide an enhanced signing or autographing experience for signer or autographer (not shown in the drawings) of the collectibles 12. Each collectible may be carefully housed, stored, retained, protected in its own dedicated storage area 20. Further, the kit 36 may be adapted, configured, designed, shaped, and/or sized to create, provide, or generate a perceived sense of value of the collectibles 12. As a result, the kit 36 may encourage the signer or autographer to handle the collectibles 12 with extra or improved care which may ensure that each collectible 12 remains or is maintained in an original, pristine, untouched, and/or flawless condition throughout the signing or autographing method or process. In some embodiments, the holder 10 of the kit 36 may be, comprise, or consist of a plurality of nine-pocket binder pages, wherein each pocket has the window 24 to minimize direct contact with the collectible 12 retained within each pocket. In at least one embodiment, the present method disclosed herein stores a set of the collectibles 12 within the binder 32 which is housed within the kit 36. As a result, the present methods disclosed herein may improve the signing or autograph process by making the signing or autographing process more efficient and/or more organized. Moreover, the present methods disclosed herein may not only protect the collectibles but may also offer the signer or autographer a smooth, improved, and/or streamlined signing process or experience.

The container 38 may be adapted, configured, designed, shaped, and/or sized to provide optimal protection, durability, and preservation of the collectibles 12 during transport, shipping, autographing, and/or storage of the collectibles 12. The materials used for the container 38 may be dependent upon the type of the collectibles 12 and/or a level of sensitivity of the collectibles 12 to one or more environmental factors selected from the group consisting of moisture, temperature, impact, and a combination thereof. The container 38 may comprise one or more materials selected from the group consisting of one or more archival-grade materials, bubble wrap, corrugated cardboard, one or more desiccants or silica gel, one or more foam inserts, one or more plastic containers, expanded polystyrene, molded pulp one or more temperature-controlled packaging items, and a combination thereof.

In one or more embodiments, the holder 10 is a multi-layer protective collectible holder that may comprise at least one core layer 18 disposed between the backing and cover layers 14, 16 as shown in FIGS. 9-19. In some embodiments, the cover layer 16 comprises a plurality of the windows 24 for accessing a plurality of exposed portions 12′ of a plurality of collectibles 12 that may be retained, disposed, or held within a plurality of the storage areas 20 of the core layer 18.

In one or more embodiments, the holder 10 is a three-layer system, wherein the backing layer 14 may be a sturdy and rigid backer and/or transparent acrylic backer that may allow for quick and easy inspection of the collectibles retained within the holder 10. The core layer 18 may be a rigid layer and/or an acrylic layer that may be precisely adapted, configured, cut, designed, shaped, and/or sized to hold, index, retain, protect, and/or store the collectibles 12 according to the thickness(es) of each collectible 12. The cover layer 16 with the widows 24 may cover, seal, and/or enclose one or more portions of the collectibles 12 inside the storage areas 20 of the holder 10.

In some embodiments, the present methods disclosed herein may comprise the signer or autographer receiving the collectibles 12 securely enclosed or retained between the three-layer system and/or signing or autographing the exposed portions 12′ of the collectibles 12 through the windows 24 of the holder 10. In at least one embodiment, the cover layer 16 may be magnetically connected, attached, coupled, or affixed to the core layer 18 and/or the backing layer 14 via the magnets 17. In an embodiment, the storage areas 20 of the core layer 18 may be precise cutouts that are adapted, configured, designed, shaped, and/or sized to receive, retain, and/or store the collectibles 12 and/or the cover layer 16 may provide the windows 24 aligned or substantially aligned with signing areas or the exposed areas 12′ of the collectibles 12. The present methods disclosed herein may securely dispose and/or sandwich the collectibles 12 within the storage areas 20 between the backing layer 14, the cover layer 16, and/or the core layer 18 (collectively referred to hereinafter as “the layers 14, 16, 18”) such that only the exposed areas 12′ of the collectibles 12 may be accessible through or via the windows 24, as shown in FIGS. 9-19.

In at least one embodiment, the holder 10 is adapted, configured, designed, shaped, and/or sized to protect and preserve the collectibles 12 from physical damage, environmental factors, and/or general wear and tear. The holder 10 may be made of one or more materials that exhibit or provide at least one physical property selected from the group consisting of durability, clarity, and protective properties. In some embodiments, at least one layer of the layers 14, 16, 18 may be made of at least one material selected from the group consisting of polypropylene, rigid polyvinyl chloride, polystyrene, acrylic, polystyrene, acid-free materials, UV-protective materials, and a combination thereof.

As shown in FIG. 9, and 12-14, the backing layer 14 has a total backing thickness T1 defined between a front side 50 and an opposite rear side 52, an outer perimeter surfaces 54 connecting the front side 50 and the opposite rear side 52, and/or the total backing thickness T1 of the backing layer 14 may be continuous and/or uninterrupted between the outer perimeter surfaces 54 of the backing layer 14. One or more surfaces of the front side 50 and the opposite rear side 52 between the outer perimeter surfaces 54 of the backing layer 14 may be planar with respect to each other. In some embodiments, the backing layer 14 may be made of or from at least one material selected from the group consisting of transparent material, at least one semi-transparent material, at least one opaque material, and a combination thereof. Additionally, the at least one material of the backing layer 14 may be a plastic material, a polymer-based material, a composite material, or a combination thereof.

As shown in FIGS. 9, 12-14, 16, and 18, the core layer 18 has a total core thickness T2 defined between a front side 56 and an opposite rear side 58, an outer perimeter surfaces 60 connecting the front side 56 and the opposite rear side 58, and/or the total core thickness T2 of the core layer 18 may be continuous and/or uninterrupted between the outer perimeter surfaces 60 of the core layer 18. One or more surfaces of the front side 56 and the opposite rear side 58 between the outer perimeter surfaces 60 of the core layer 18 may be planar with respect to each other. The storage areas 20 may be cut, disposed, formed, located, positioned, and/or provided in the core layer 18, as shown in FIGS. 9, 14, 16, and 18. In some embodiments, the storage areas 20 may extend through the entire total core thickness T2 of the core layer 18 or through at least a portion or substantial portion of the total core thickness T2 of the core layer 18. The storage areas 20 and/or the total core thickness T2 may be adapted, configured, designed, shaped, and/or sized to receive the collectibles 12, as shown in FIGS. 16 and 18. As a result, the collectibles 12 may be housed, protected, retained, and/or stored within the storage areas 20 of the core layer 18 and/or the storage areas 20 may be adapted, configured, shaped, and/or sized such that the collectibles 12 may be removably connected, coupled, or affixed to the core layer 18. In some embodiments, the core layer 18 may be made of or from at least one material selected from the group consisting of transparent material, at least one semi-transparent material, at least one opaque material, and a combination thereof. Additionally, the at least one material of the core layer 18 may be a plastic material, a polymer-based material, a composite material, or a combination thereof.

In one or more embodiments, the storage areas 20 of the core layer 18 may have, comprise, or consist of one or more recesses 68 (hereinafter “the recess 68”) that extend along at least one or more portions of the perimeters and/or the circumferences of the storage areas 20 as shown in FIGS. 9, 10, 14-16, and 18. A finger of a user (not shown in the drawings) may be insertable into at least one of the recess 68 to facilitate removal of the collectible 12 from the storage area 20 of the core layer 18. In some embodiments, the recess 68 may provide spacing between the core layer 18 and one or more outer edges, corners, surfaces, perimeters, and/or circumferences of the collectibles 12 retained and/or protected within the storage areas 20, as shown in FIG. 10. In some embodiments, the recess 68 may be provided on the front side 56 of the core layer 18 and/or adjacent to the cover layer 16 when or while the cover layer 16 is removably attached, connected, coupled, and/or affixed to the core layer 18 and/or the core layer 18 is disposed, located, positioned, and/or provided adjacent to the cover layer 16. In at least one embodiment, the recess 68 may have a circular or curved geometry and/or at least one geometry dependent upon the configuration, design, shape, and/or size of the collectible 12 retained within the storage area.

As shown in FIGS. 9-19, the cover layer 16 has a total cover thickness T3 defined between a front side 62 and an opposite rear side 64, an outer perimeter surfaces 66 connecting the front side 62 and the opposite rear side 64, and/or the total cover thickness T3 of the cover layer 16 may be continuous and/or uninterrupted between the outer perimeter surfaces 66 of the cover layer 16. One or more surfaces of the front side 62 and the opposite rear side 64 between the outer perimeter surfaces 66 of the cover layer 16 may be planar with respect to each other. In some embodiments, the cover layer 16 may be made of or from at least one material selected from the group consisting of transparent material, at least one semi-transparent material, at least one opaque material, and a combination thereof. Additionally, the at least one material of the cover layer 16 may be a plastic material, a polymer-based material, a composite material, or a combination thereof.

The windows 24 of the cover layer 16 may be cut, disposed, formed, located, positioned, and/or provided in the cover layer 16, as shown in FIGS. 9-11 and 14-19. The windows 24 extend through the entire total cover thickness T3 such that the exposed portion 12′ of the collectibles 12 is visible and accessible for signing or autographing when or while the collectibles 12 are retained within the core layer 18 or the holder 10, the holder 10 is in the first or closed position, and/or the cover layer 16 is removably attached, connected, coupled, or affixed to the core layer 18, as shown in FIGS. 10, 11, 15, 17, and 19. The signer or autographer may access and sign or autograph, with the writing device 26, the signing area or exposed portion 12′ of the collectibles 12 through the windows 24 when or while the collectibles 12 are retained within the core layer 18 or the holder 10, the holder 10 is in the first or closed position, and/or the cover layer 16 is removably attached, connected, coupled, or affixed to the core layer 18, as shown in FIGS. 17 and 19.

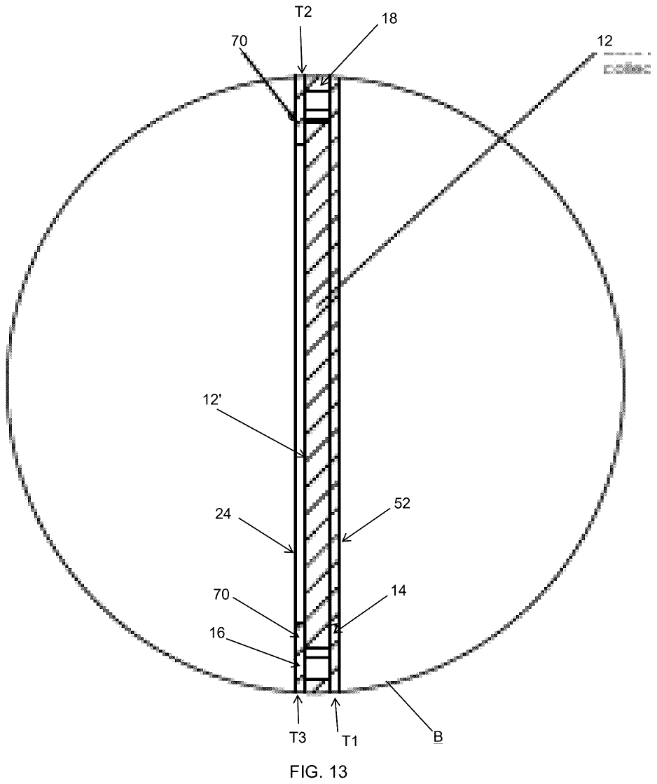

In some embodiments, at least one flange or lip 70 (hereinafter “the lip 70”) may be created, disposed, formed, located, positioned, and/or provided adjacent to the windows 24, the storage areas 20, and/or the collectibles 12 when or while the cover layer 16 is removably attached, connected, coupled, and/or affixed to the core layer 18 as shown in FIG. 13. As a result, the lip 70 may disposed, formed, located, positioned, and/or provided adjacent to the front side 56 of the core layer 18 and/or the exposed portion 12′ of the collectible 12 such that the one or more remaining portions of the collectible 12 are and/or remain concealed, covered, protected, and/or unexposed by or between the lip 70 and/or the cover layer 16 and the backing layer 16 and/or the core layer 18. In at least one embodiment, the lip 70 may retain the collectibles 12 in the holder 10 such that the collectibles 12, excluding the signing areas or exposed portions 12′, are protected and retained within the storage areas 20 and/or the holder 10 during shipping or transporting the kit 36 to the signer or autographer and during signing or autographing by the signer or autographer.

In FIG. 20, the kit 36 may comprise one or more of the holders 10, as shown in FIGS. 17 and/or 19, and/or the kit 36 and holder(s) 10 contained therein may retain and/or protect the collectibles 12 therein during the shipping or transporting the kit 36 and/or during the signing or autographing of the collectibles 12 by the signer or autographer. As a result, the one or more remaining portions of the collectibles 12, excluding the signing areas and exposed portions 12′, are protected and/or remain protected from damage during the present autographing processes or methods as disclosed herein.

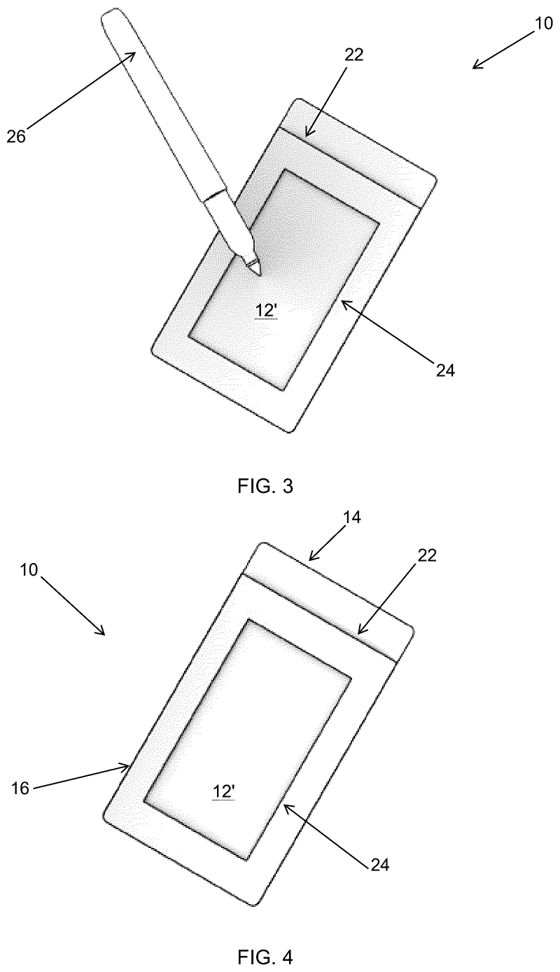

In one or more embodiments, the window 24 of the holder 10 may be adapted, configured, designed, shaped, and/or sized such that all edges of the collectible 12 may be covered, retained, and/or protected by the cover layer 16 for protection of all edges of the collectible 12, as shown in FIGS. 2-5, 7, 10, 11, and 15-19. As a result, all edges of the collectible 12 are not accessible through the window 24 when the cover layer 16 is adjacent to and/or in contact with the core layer 18 and/or the backing layer 14. In some embodiments, the window 24 may only be large enough to allow for the signing or autographing of the signing area and exposed portions 12′ of the collectible 12 while the cover layer 16 may be retained protectively over the remaining or unexposed portions of the collectible 12. In at least one embodiment, the total height of the window 24 may be sized such that the exposed portion 12′ of the collectible 12 may be about half or less than about half of the total height of the collectible 12, as shown in FIGS. 4-7 and 16-19.

In some embodiments, the window 24 of the holder 10 may be openable and closable via a hinged flap (not shown in the drawings) of the cover layer 16. For example, the cover layer 16, as shown in FIGS. 17 and 19 may have hinged flaps that cover and/or close the windows 24 such that when the hinged flaps are in a closed position the exposed portions 12′ of the collectibles 12 are not accessible through the windows 24 and are covered and/or protected by the hinged flaps of the cover layer 16. As a result, all surfaces and/or all edges of the collectibles 12 may be cover, non-accessible, and protected by the holder 10, the backing, cover, and core layer 14, 16, 18, and/or the hinged flaps when the hinged flaps are in the closed position. When the hinged flaps are disposed in or moved to the open positioned, the signing area and/or exposed portions 12′ are accessible through the windows 24 for signing or autographing by the signer or autographer. In at least one embodiment, the hinged flap and/or the cover layer 16 may have a tab or finger cutout that may be adapted, configured, sized, and/or shaped to facilitate movement of the hinged flap from the closed position to the open position for signing or autographing the signing area or exposed portion 12′ of the collectible through the window 24.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific examples are presented for purposes of illustration and description. They are not intended to be exhaustive of or to limit this disclosure to the precise forms described. Obviously, many modifications and variations are possible in view of the above teachings. The examples are shown and described in order to best explain the principles of this disclosure and practical applications, to thereby enable others skilled in the art to best utilize this disclosure and various examples with various modifications as are suited to the particular use contemplated. It is intended that the scope of this disclosure be defined by the claims and their equivalents below.

What is claimed is:

1. A protective holder configured to retain at least one collectible, the protective collectible holder comprising:
a storage area disposed between a backing layer and a cover layer and configured to receive and retain a collectible therein;
an opening disposed between the backing layer and the cover layer and configured such that the collectible is insertable into the storage area through the opening; and
an autograph window extending through a total thickness of the cover layer such that an exposed portion of the collectible is accessible for autographing through the autograph window when the collectible is disposed within the storage area.

2. The protective holder of claim 1, wherein the backing layer and the cover layer are integrally formed together.

3. The protective holder of claim 1, wherein the cover layer is movably connected to the backing layer.

4. The protective holder of claim 3, further comprising:
a hinge or magnets movably connecting the cover layer to the backing layer.

5. The protective holder of claim 3, further comprising:
a core layer connected to the backing layer and comprising the storage area configured to receive the collectible therein when the protective holder is disposed in an open configuration.

6. The protective holder of claim 5, wherein the core layer is disposed between the backing layer and the cover layer when the protective holder is disposed in a closed configuration.

7. The protective holder of claim 6, wherein an exposed portion of the collectible is accessible through the autograph window when the collectible is retained within the storage area of the core layer and the protective holder is disposed in the closed configuration.

8. The protective holder of claim 1, further comprising:
at least one lip of the cover layer disposed adjacent to the autograph window such that the at least one lip covers at least one unexposed portion of the collectible when the collectible is retained within the storage area.

9. The protective holder of claim 1, wherein all edges of the collectible are covered by portions of the cover layer adjacent to the window when the collectible, in its entirety, is disposed between the backing layer and the cover layer or the holder is disposed in a closed position such that the cover layer is adjacent to the core layer.

10. An autograph system comprising:
the protective holder according to claim 1; and
a collectible retained within the storage area of the protective holder such that an exposed portion of the collectible is accessible for autographing through the autograph window of the protective holder.

11. The autograph system of claim 10, wherein the collectible retained within the storage area is a collectible trading card.

12. The autograph system of claim 10, wherein the protective holder is a semi-rigid card holder configured to retain the collectible trading card therein or the autograph window is movable with respect to the exposed portion of the collectible trading card.

13. The autograph system of claim 10, wherein the protective holder further comprises a core layer comprising the storage area and connected to the backing layer, wherein the cover layer is movably connected to the core layer or the cover layer.

14. A method to protect at least one collectible, the method comprising:
retaining a collectible in the storage area of the protective holder according to claim 1 such that an exposed portion of the collectible is accessible for autographing through the autograph window of the protective holder.

15. The method of claim 14, further comprising:
autographing the exposed portion of the collectible through the autograph window.

16. The method of claim 14, further comprising:
packing the protective holder and retained collectible into container of a kit.

17. The method of claim 16, further comprising:
shipping or transporting the kit.

18. The method of claim 16, further comprising at least one:
receiving the shipped or transported kit; and
removing the packed protective holder and retained collectible from the kit.

19. The method of claim 14, wherein the retained collectible is a collectible trading card.

20. The method of claim 19, further comprising:
inserting the collectible trading care into a semi-rigid card holder as the protective holder.
